(19) United States
(12) Patent Application Publication
(10) Pub. No.: US 2018/0357085 A1
(43) Pub. Date: Dec. 13, 2018

(54) METHOD AND APPARATUS FOR RUNNING ANDROID APPLICATION ON WINDOWS SYSTEM

(71) Applicant: BEIJING QIHOO TECHNOLOGY COMPANY LIMITED, Beijing (CN)

(72) Inventors: Han YAN, Beijing (CN); Xin RAN, Beijing (CN); Zhihui LIANG, Beijing (CN)

(21) Appl. No.: 15/741,179

(22) PCT Filed: Nov. 1, 2016
(86) PCT No.: PCT/CN2016/104235

§ 371 Date: Dec. 29, 2017

(30) Foreign Application Priority Data
Aug. 10, 2016 (CN) 201610652849.6

(51) Int. Cl. G06F 9/455; G06F 9/445

(52) U.S. Cl. CPC G06F 9/45537; G06F 9/44521; G06F 9/4552

(57) ABSTRACT

A method and apparatus for running an Android application on a Windows system are disclosed. The method comprises: loading a relevant file in a dynamic link library of an Android virtual machine by loading a Linux executable file of a predetermined format in response to an instruction for starting an application to start the Android virtual machine; beginning to load the relevant file in the dynamic link library of the application; loading a predetermined engine file and a relevant executable file in the application by starting the Android virtual machine; invoking an Activity resource corresponding to the application by invoking a predetermined starting process; and finishing loading the relevant file in the dynamic link library of the application in a life cycle of the Activity resource to run the application. Through the present invention, normal running of an Android application in the Windows system in the form of a native application is thoroughly implemented. Meanwhile, normal and fast running of the Android application in the Windows system may be implemented without users' complex operations, and thus use experience may be further improved for the users

### TECHNICAL FIELD

The present invention relates to the field of computer technologies, and particularly to a method for running an Android application on a Windows system, an apparatus for running an Android application on a Windows system, a computer program and a computer-readable medium.

### BACKGROUND

With constant development of computer technologies, in daily lives, people increasingly rely on various applications, and people's usage requirements for the applications are also increasingly diversified. When users use game applications on mobile terminals of Android operating systems, the users expect to realize operation experiences of the applications in personal computers (PCs) of Windows operating systems, so that the users can enjoy more convenient and more smooth operation experiences on larger display screens, thereby solving a problem of poor visual experience due to smaller screens of the mobile terminals. Meanwhile, it is avoidable that game halt is caused by overheating of processors of the mobile terminals, and it is avoidable that the users' game control is interrupted by unstable network signal of the mobile terminals.

In the prior art, first of all, a virtual machine needs to be installed on a PC of the Windows operating system, a virtual Android operating system is operated in the virtual machine, and later an Android application is installed and run in the virtual Android operating system. In one aspect, in the process of installing a virtual machine, a complete set of kernel-level drivers of the virtual machine may be installed; and in the running process of an application, invoking each kernel driver is extremely complex, and system resources are consumed. In another aspect, the running of the virtual machine needs to consume a large amount of hard disk space and a memory of a PC, which may reduce a response speed of running of each process of the PC. In still another aspect, the implementation of the prior art is greatly dependent on virtualized hardware acceleration techniques of a central processing unit (CPU) of the PC. Over the past few decades, rapid popularization of hardware virtualization technologies makes computer performance better and better. However, to avoid the occurrence of various potential safety hazards, after manufacturing of more than 70% of main boards is completed, implementation of the hardware virtualization technologies is prohibited in the basic input output system (BIOS). Consequently, a large number of users' demands cannot be satisfied, and thus the user experience is reduced. Further, the virtual machine essentially is provided to business users and geek users having professional knowledge for use, which may bring great operation difficulties to ordinary users in a using process, thereby limiting the development of user groups.

### SUMMARY

To overcome the aforementioned technical problems or to at least in part solve the aforementioned technical problems, following technical solutions are particularly proposed.

An embodiment of the present invention provides a method for running an Android application on a Windows system, which comprises: loading a relevant file in a dynamic link library of an Android virtual machine by loading a Linux executable file of a predetermined format in response to an instruction for starting an application to start the Android virtual machine; beginning to load the relevant file in the dynamic link library of the application; loading a predetermined engine file and a relevant executable file in the application by starting the Android virtual machine; invoking an Activity resource corresponding to the application by invoking a predetermined starting process; and finishing loading the relevant file in the dynamic link library of the application in a life cycle of the Activity resource to run the application.

Another embodiment of the present invention provides an apparatus for running an Android application on a Windows system, which comprises: a first loading module, configured to load a relevant file in a dynamic link library of an Android virtual machine by loading a Linux executable file of a predetermined format in response to an instruction for starting an application to start the Android virtual machine; a second loading module, configured to begin to load the relevant file in the dynamic link library of the application; a third loading module, configured to load a predetermined engine file and a relevant executable file in the application by starting the Android virtual machine; an invoking module, configured to invoke an Activity resource corresponding to the application by invoking a predetermined starting process; and a fourth loading module, configured to finish loading the relevant file in the dynamic link library of the application in a life cycle of the Activity resource to run the application.

An embodiment of the present invention further provides a computer program, comprising a computer-readable code which causes a computing device to perform the method for running an Android application on a Windows system according to any one of the embodiments of the present invention when the computer-readable code is running on the computing device.

Another embodiment of the present invention further provides a computer-readable medium storing the computer program of the embodiment of the present invention is stored.

The embodiment of the present invention proposes a solution for running an Android application on a Windows system. A relevant file in a dynamic link library of an Android virtual machine is loaded by loading a Linux executable file of a predetermined format in response to an instruction for starting the application to start the Android virtual machine, thereby implementing normal running of the Android virtual machine on the Windows system and providing important premise and guarantee for implementing normal running of the Android application on the Windows system. It is began to load the relevant file in the dynamic link library of the application, and it is implemented that less system resources are occupied in the running process of the Android application by starting the Android virtual machine to load a predetermined engine file and a relevant executable file in the application and by running the application in a customized and simplified Android system, thereby solving problems of sluggish or slow running of the Android application in the Windows system. Loading the relevant file in the dynamic link library of the application is finished in a life cycle of the Activity resource by invoking a predetermined starting process and invoking an Activity resource corresponding to the application. In this way, normal running of the Android application in the Windows system in the form of a native application is thoroughly implemented. Meanwhile, normal and fast running of the Android application in the Windows system is implemented without users' complex operations, and thus use experience is further improved for the users.

Additional aspects and advantages of the present invention will be set forth in the description which follows and will be apparent from the description, or may be learned by practice of the present invention.

### BRIEF DESCRIPTION OF THE DRAWINGS

The above and/or additional aspects and advantages of the present invention will become apparent and readily comprehensible from the following description of embodiments with reference to the accompanying drawings, in which,

FIG. 1 is a flowchart of a method for running an Android application on a Windows system according to an embodiment of the present invention;

FIG. 2 is a schematic structural diagram of an apparatus for running an Android application on a Windows system according to another embodiment of the present invention;

FIG. 3 is a schematic structural diagram of an apparatus for running an Android application on a Windows system according to still another embodiment of the present invention;

FIG. 4 illustrates a block diagram of a computing device for executing the method for running an Android application on a Windows system according to the present invention; and

FIG. 5 illustrates a memory cell for maintaining or carrying a program code for implementing the method for running an Android application on a Windows system according to the present invention.

### DESCRIPTION OF THE EMBODIMENTS

The embodiments of the present invention will be described in detail as below. Examples of the embodiments are as shown in drawings, in which same or similar reference numbers always represent same or similar elements or elements with same or similar functions. The embodiments described with reference to the drawings are exemplary, just used for explaining the present invention, not for limiting the present invention.

A person skilled in the art may understand that “a”, “an”, “said” and “the” may also refer to plural nouns, unless otherwise specifically stated. It should be further understood that, phraseology “include” used in the specification of the present invention refers to the presence of the characteristics, integers, steps, operations, elements and/or components, but not exclusive of the presence or addition of one or more other characteristics, integers, steps, operations, elements, components and/or groups thereof. It should be understood that when we mention that an element is “connected” or “coupled” to another element, it may be directly connected or coupled to the other elements, or intermediate elements may be available. In addition, “connection” or “coupling” used herein may include wireless connection or coupling. The phraseology “and/or” includes any one unit and all combinations of one or more associated listed items.

A person skilled in the art may understand that, unless otherwise defined, all terms (including technical terms and scientific terms) used herein have the same meaning as commonly understood by an ordinary person skilled in the art to which the present invention belongs. It should also be understood that terms such as those defined in commonly used dictionaries should be interpreted as having a meaning that is consistent with their meaning in the context of the prior art, and will not be interpreted in an idealized or overly formal sense unless expressly so defined herein.

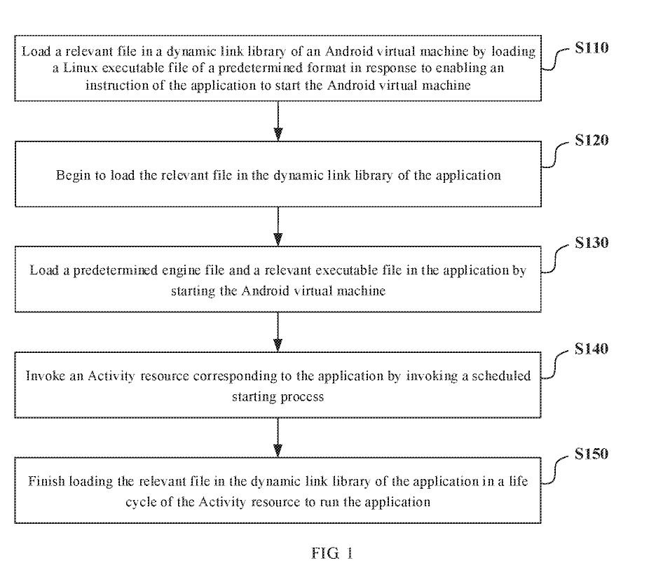

FIG. 1 is a flowchart of a method for running an Android application on a Windows system according to an embodiment of the present invention.

In the embodiment of the present invention, contents executed in steps are outlined as below: Step S110: loading a relevant file in a dynamic link library of an Android virtual machine by loading a Linux executable file of a predetermined format in response to an instruction for starting the application to start the Android virtual machine; Step S120: beginning to load the relevant file in the dynamic link library of the application; Step S130: loading a predetermined engine file and a relevant executable file in the application by starting the Android virtual machine; Step S140: invoking an Activity resource corresponding to the application by invoking a predetermined starting process; and Step S150: finishing loading the relevant file in the dynamic link library of the application in a life cycle of the Activity resource to run the application.

The embodiment of the present invention proposes a method for running an Android application on a Windows system. A relevant file in a dynamic link library of an Android virtual machine is loaded by loading a Linux executable file of a predetermined format in response to an instruction for starting the application to start the Android virtual machine, thereby implementing normal running of the Android virtual machine in the Windows system and providing important premise and guarantee for implementing normal running of the Android application on the Windows system. It is began to load the relevant file in the dynamic link library of the application, and it is implemented that less system resources are occupied in the running process of the Android application by starting the Android virtual machine to load a predetermined engine file and a relevant executable file in the application and by running the application in a customized and simplified Android system, thereby solving problems of sluggish or slow running of the Android application in the Windows system. Loading the relevant file in the dynamic link library of the application is finished in a life cycle of the Activity resource by invoking a predetermined starting process and invoking an Activity resource corresponding to the application. In this way, normal running of the Android application in the Windows system in the form of a native application is thoroughly implemented. Meanwhile, normal and fast running of the Android application in the Windows system is implemented without users' complex operations, and thus use experience is further improved for the users. Concrete implementation of each step is further described as below.

Step S110: loading a relevant file in a dynamic link library of an Android virtual machine by loading a Linux executable file of a predetermined format in response to an instruction for starting the application to start the Android virtual machine.

For example, an application layer of the Android operating system is written by using a Java language. Therefore, in a running process of the Android virtual machine, Java-related files may be loaded. When an App1 runs in the Android virtual machine, a relevant essential library of the Android virtual machine is first loaded after the Android virtual machine runs, such as a customized CRT-related library essential to running a Java virtual machine Dalvik of the Android system, including interfaces having implemented libc.so, OpenGL ES interfaces, OpenSL ES interfaces and a part of Android Native Development Kit (Android NDK) interfaces or the like. Later, by loading a Linux executable file of a predetermined format, such as a relevant file of an ELF format, the Android virtual machine loads relevant files (for example, predetermined relevant .so files of the Java virtual machine Dalvik of the Android system, and relevant files of a math library libm.so, or the like) in the dynamic link library of the Android virtual machine to start the Java virtual machine Dalvik of the Android system.

Preferably, Step S110 of loading a relevant file in a dynamic link library of an Android virtual machine specifically includes Step S111 (not shown in the figures): loading the relevant file in the dynamic link library of the Android virtual machine by a predetermined starting process.

For example, loading a relevant file (for example, a predetermined relevant .so file of the Java virtual machine Dalvik of the Android system) in the dynamic link library of the Android virtual machine is started by invoking processes of a related class of a customized Android Framework and of other Java-related classes.

Step S120: beginning to load the relevant file in the dynamic link library of the application.

For example, when the App1 runs in the Android virtual machine, a relevant essential library of the Android virtual machine is loaded after the Android virtual machine runs the App1, after which loading a relevant file (for example, the relevant .so file of the App 1) in the dynamic link library of the App1 may be started.

Step S130: loading a predetermined engine file and a relevant executable file in the application by starting the Android virtual machine.

The predetermined engine file includes a DEX-related file of an Android system, a relevant file in a dynamic link library of the Android system, and a relevant file in a dynamic link library of the application.

For example, after the Java virtual machine Dalvik of the Android system is started, the predetermined engine file and a relevant executable file (for example, a predetermined relevant .so file in the system library of the Android system) in the App1 are loaded. The predetermined relevant .so files in the system library of the Android system are files in a simplified Android operating system. The predetermined relevant .so files in the system library of the Android system include essential relevant files in the Android system. Unessential Android system files (for example, files related to power management in the Android system) in Windows, DEX-related files (for example, classes.dex code files for encapsulating program codes for implementing various Android modules) of the Android system and App1-related .so files are deleted.

Step S140: invoking an Activity resource corresponding to the application by invoking a predetermined starting process.

For example, the Activity resource of the Android system is invoked by invoking processes of a related class of a customized Android Framework and of other Java-related classes. In the Android system, all operations in the Activity are closely related to a user, serving as a component in charge of interacting with the user.

It is to be noted that those skilled in the art may realize that the Android operating system has principles different from other operating systems in that the Android provides developers with four components, specifically Activity, Service, Broadcast Receiver and Content Provider. The Content Provider belongs to one of components of Android applications. As the only way to share data among applications, the Content Provider has major functions of storing and retrieving data and providing other applications with data accessing interfaces. The Activity serves as a component in charge of interacting with users in Android applications. The Service usually runs in background and generally does not need to interact with the users. Therefore, the Service has no graphical user interface. The Service may have its independent life cycle after it runs. The Service usually is configured to provide background services for other modules or monitor running states of the other modules. The Broadcast Receiver represents a broadcast message receiver.

Step S150: finishing loading the relevant file in the dynamic link library of the application in the life cycle of the Activity resource to run the application.

Preferably, loading the relevant file in the dynamic link library of the application may be finished by the predetermined starting process in the life cycle of the Activity.

In the Android, the life cycle of the Activity refers to a course from starting the Activity to destroying the Activity. In the life cycle of the Activity resource, for example, loading a relevant .so file of the App1 may be finished by invoking processes of a related class of the customized Android Framework and of other Java-related classes to run the App1.

In a preferred embodiment, the method further includes Step S160 (not shown in the figures): receiving a Windows operating instruction of the application, and converting the Windows operating instruction to a corresponding Android operating instruction by the Android virtual machine.

For example, the Android virtual machine has a customized CRT library and other underlying libraries, which may support to load a relevant file, for example libdvm.so (that is, the Java virtual machine Dalvik of the Android system), in the dynamic link library of the Android virtual machine by loading a Linux executable file (for example, a relevant file of an ELF format) of a predetermined format. Therefore, when a user executes a relevant operation such as a mouse clicking operation of the App1 in the Windows operating system, after a mouse clicking instruction of the App1 is received, a Windows mouse clicking operating instruction is converted, by the Android virtual machine, to a corresponding Android mouse clicking operating instruction to implement proper running of the App 1.

In a preferred embodiment, the method further includes Step S170 (not shown in the figures) and Step S180 (not shown in the figures), Step S170: sending the converted Android operating instruction to the relevant file in the dynamic link library of the application; and Step S180: executing, by the application, a corresponding operation in the Windows system according to the received and converted Android operating instruction.

Preferably, sending the converted Android operating instruction to the relevant file in the dynamic link library of the application includes at least one of following cases.

The converted Android operating instruction is sent to the relevant file in the dynamic link library of the application according to a notification message of the Android virtual machine.

The converted Android operating instruction acquired by invoking is fed back to the relevant file in the dynamic link library of the application according to an invoked instruction of the application.

For example, the converted Android operating instruction such as a converted Android mouse clicking operating instruction is sent to the relevant .so file of the App1 according to a reflection mechanism in the Java virtual machine Dalvik of the Android system and to a Java Native Interface (JNI). The App1 executes the corresponding mouse clicking operation in the Windows system according to the received and converted Android mouse clicking operating instruction.

It is to be noted that the reflection mechanism adopted in this embodiment may be a Java reflection mechanism, according to which, for any a class in a running state, all attributes and methods of the class may be known. The function of the method for dynamically obtaining information and dynamically invoking objects is the reflection mechanism of the Java language.

For another example, the converted Android mouse clicking operating instruction is sent to the relevant .so file of the App1 via a predetermined invocation interface. The App1 executes the corresponding mouse clicking operation in the Windows system according to the received and converted Android mouse clicking operating instruction.

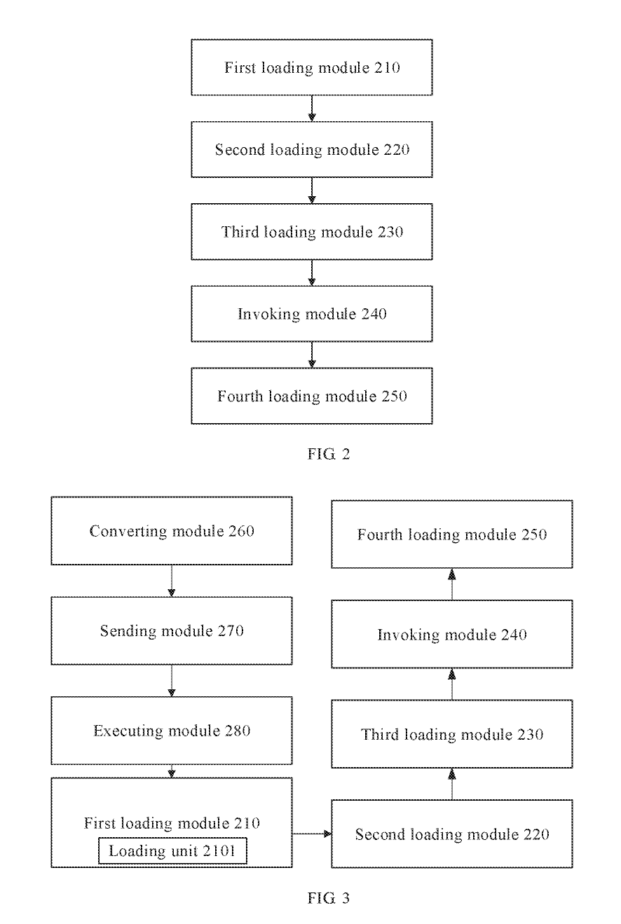

FIG. 2 is a schematic structural diagram of an apparatus for running an Android application on a Windows system according to another embodiment of the present invention.

In the embodiment of the present invention, contents executed by modules are outlined as below: a first loading module 210 loads a relevant file in a dynamic link library of an Android virtual machine by loading a Linux executable file of a predetermined format in response to an instruction for starting the application to start the Android virtual machine. The second loading module 220 begins to load the relevant file in the dynamic link library of the application. The third loading module 230 loads a predetermined engine file and a relevant executable file in the application by starting the Android virtual machine. The invoking module 240 invokes an Activity resource corresponding to the application by invoking a predetermined starting process. The fourth loading module 250 finishes loading the relevant file in the dynamic link library of the application in a life cycle of the Activity resource to run the application.

The embodiment of the present invention proposes an apparatus for running an Android application on a Windows system. A relevant file in a dynamic link library of an Android virtual machine is loaded by loading a Linux executable file of a predetermined format in response to an instruction for starting the application to start the Android virtual machine, thereby implementing normal running of the Android virtual machine in the Windows system and providing important premise and guarantee for implementing normal running of the Android application on the Windows system. It is began to load the relevant file in the dynamic link library of the application, it is implemented that less system resources are occupied in the running process of the Android application by starting the Android virtual machine to load a predetermined engine file and a relevant executable file in the application and by running the application in a customized and simplified Android system, thereby solving problems of sluggish or slow running of the Android application in the Windows system. Loading the relevant file in the dynamic link library of the application is finished in a life cycle of the Activity resource by invoking a predetermined starting process and invoking an Activity resource corresponding to the application. In this way, normal running of the Android application in the Windows system in the form of a native application is thoroughly implemented. Meanwhile, normal and fast running of the Android application in the Windows system is implemented without users' complex operations, and thus use experience is further improved for the users. Concrete implementation of each module is further described as below.

The first loading module 210 is configured to load a relevant file in the dynamic link library of an Android virtual machine by loading a Linux executable file of a predetermined format in response to an instruction for starting an application to start the Android virtual machine.

For example, an application layer of the Android operating system is written by using a Java language. Therefore, in a running process of the Android virtual machine, Java-related files may be loaded. When an App1 runs in the Android virtual machine, a relevant essential library of the Android virtual machine is first loaded after the Android virtual machine runs, such as a customized CRT-related library essential to running a Java virtual machine Dalvik of the Android system, including interfaces having implemented libc.so, OpenGL ES interfaces, OpenSL ES interfaces and a part of Android Native Development Kit (Android NDK) interfaces or the like. Later, by loading a Linux executable file of a predetermined format, such as a relevant file of an ELF format, the Android virtual machine loads relevant files (for example, predetermined relevant .so files of the Java virtual machine Dalvik of the Android system, and relevant files of a math library libm.so, or the like) in the dynamic link library of the Android virtual machine to start the Java virtual machine Dalvik of the Android system.

FIG. 3 is a schematic structural diagram of an apparatus for running an Android application on a Windows system according to still another embodiment of the present invention.

Preferably, the first loading module 210 includes a loading unit 2101, which is configured to load the relevant file in the dynamic link library of the Android virtual machine by the predetermined starting process.

For example, loading a relevant file (for example, a predetermined relevant .so file of the Java virtual machine Dalvik of the Android system) in the dynamic link library of the Android virtual machine is started by invoking processes of a related class of a customized Android Framework and of other Java-related classes.

The second loading module 220 is configured to begin to load the relevant file in the dynamic link library of the application.

For example, when the App1 runs in the Android virtual machine, a relevant essential library of the Android virtual machine is loaded after the Android virtual machine runs the App1, after which loading a relevant file (for example, the relevant .so file of the App1) in the dynamic link library of the App1 may be started.

The third loading module 230 is configured to load a predetermined engine file and a relevant executable file in the application by starting the Android virtual machine.

The predetermined engine file includes a DEX-related file of an Android system, a relevant file in a dynamic link library of the Android system, and a relevant file in a dynamic link library of the application.

For example, after the Java virtual machine Dalvik of the Android system is started, the predetermined engine file and a relevant executable file (for example, a predetermined relevant .so file in the system library of the Android system) in the App1 are loaded. The predetermined relevant .so files in the system library of the Android system are files in a simplified Android operating system. The predetermined relevant .so file in the system library of the Android system includes an essential relevant file of the Android system. Unessential Android system files (for example, files related to power management in the Android system) in Windows, DEX-related files (for example, classes.dex code files for encapsulating program codes for implementing various Android modules) of the Android system and App1 -related .so files are deleted.

The invoking module 240 is configured to invoke an Activity resource corresponding to the application by invoking a predetermined starting process.

For example, the Activity resource of the Android system is invoked by invoking processes of a related class of a customized Android Framework and of other Java-related classes. In the Android system, all operations in the Activity are closely related to a user, serving as a component in charge of interacting with the user.

It is to be noted that those skilled in the art may realize that the Android operating system have principles different from other operating systems in that the Android provides developers with four components, specifically Activity, Service, Broadcast Receiver and Content Provider. The Content Provider belongs to one of components of Android applications. As the only way to share data among applications, the Content Provider has major functions of storing and retrieving data and providing other applications with data accessing interfaces. The Activity serves as a component in charge of interacting with users in Android applications. The Service usually runs in background and generally does not need to interact with the users. Therefore, the Service has no graphical user interface. The Service may have its independent life cycle after it runs. The Service usually is configured to provide background services for other modules or monitor running states of the other modules. The Broadcast Receiver represents a broadcast message receiver.

The fourth loading module 250 is configured to finish loading the relevant file in the dynamic link library of the application in a life cycle of the Activity resource to run the application.

Preferably, loading the relevant file in the dynamic link library of the application may be finished by the predetermined starting process in the life cycle of the Activity.

In the Android, the life cycle of the Activity refers to a course from starting the Activity to destroying the Activity. In the life cycle of the Activity resource, for example, loading a relevant .so file of the App1 may be finished by invoking processes of a related class of the customized Android Framework and of other Java-related classes to run the App1.

In a preferred embodiment, the apparatus further includes a converting module 260, which is configured to receive a Windows operating instruction of the application, and convert the Windows operating instruction to a corresponding Android operating instruction by the Android virtual machine.

For example, the Android virtual machine has a customized CRT library and other underlying libraries, which may support to load a relevant file, for example libdvm.so (that is, the Java virtual machine Dalvik of the Android system), of the dynamic link library of the Android virtual machine by loading a Linux executable file (for example, a relevant file of an ELF format) of a predetermined format. Therefore, when a user executes a relevant operation such as a mouse clicking operation of the App1 in the Windows operating system, after a mouse clicking instruction of the App1 is received, the Windows mouse clicking operation is converted, by the Android virtual machine, to a corresponding Android mouse clicking operating instruction to implement proper running of the App1 .

In a preferred embodiment, the apparatus further includes a sending module 270 and an executing module 280. The sending module 270 is configured to send the converted Android operating instruction to the relevant file in the dynamic link library of the application. The executing module 280 is configured to execute a corresponding operation in the Windows system according to the received and converted Android operating instruction.

Preferably, sending the converted Android operating instruction to the relevant file in the dynamic link library of the application includes at least one of following cases.

The converted Android operating instruction is sent to the relevant file in the dynamic link library of the application according to a notification message of the Android virtual machine.

The converted Android operating instruction acquired by invoking is fed back to the relevant file in the dynamic link library of the application according to an invoked instruction of the application.

For example, the converted Android operating instruction such as a converted Android mouse clicking operating instruction is sent to the relevant .so file of the App1 according to a reflection mechanism in the Java virtual machine Dalvik of the Android system and to a Java Native Interface (JNI). The App1 executes the corresponding mouse clicking operation in the Windows system according to the received and converted Android mouse clicking operating instruction.

It is to be noted that the reflection mechanism adopted in this embodiment may be a Java reflection mechanism, according to which, for any a class in a running state, all attributes and methods of the class may be known. The function of the method for dynamically obtaining information and dynamically invoking objects is the reflection mechanism of the Java language.

For another example, the converted Android mouse clicking operating instruction is sent to the relevant .so file of the App1 via a predetermined invocation interface. The App1 executes the corresponding mouse clicking operation in the Windows system according to the received and converted Android mouse clicking operating instruction.

Device embodiments are basically similar to method embodiments, so description of device embodiments is relatively simple. Please see method embodiments which may serve as reference.

Algorithm and display provided herein are not inherently related to a particular computer, virtual system or other equipment. Various general systems may also be used with the teaching based on the present invention. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the present invention and to facilitate the understanding of one or more of various aspects thereof, in the above description of the exemplary embodiments of the present invention, various features of the present invention may sometimes be grouped together into a single embodiment, accompanying figure or description thereof. However, the method of this present invention should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the method and apparatus and device running in background applied according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

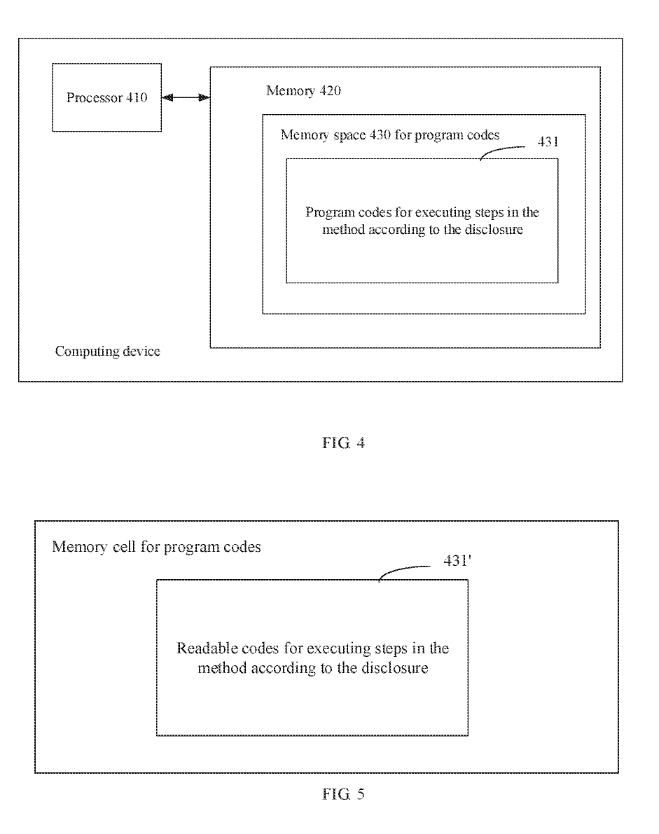

For example, FIG. 4 illustrates a computing device that may implement the method for running an Android application on a Windows system according to the present invention. Traditionally, the computing device includes a processor 410 and a program product or a computer readable medium in form of a memory 420. The memory 420 could be electronic memories such as flash memory, EEPROM (Electrically Erasable Programmable Read—Only Memory), EPROM or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more program products. These program products include program code carriers such as memory card. These program products are usually the portable or stable memory cells as shown in reference FIG. 5. The memory cells may be provided with memory sections, memory spaces, etc., similar to the memory 420 of the computing device as shown in FIG. 4. The program codes may be compressed for example in an appropriate form. Usually, the memory cell includes readable codes 431′ which can be read for example by processors 410. When these codes are operated on the computing device, the computing device may execute respective steps in the method as described above.

A person skilled in the art may understand that the present invention includes devices involved for executing one or more of the operations in the application. These devices may be specially designed and manufactured for the required purpose, or may also include known devices in general purpose computers. These devices have computer programs stored therein, which may be selectively activated or reconstructed. Such computer programs may be stored in device (for example, computer) readable medium or in any type of medium suitable for storing electronic instructions and respectively coupled to a bus. The computer readable medium may include but is not limited to any type of disk (including floppy disk, hard disk, optical disks, CD-ROM and magneto-optical disk), Read-Only Memory (ROM), Random Access Memory (RAM), Erasable Programmable Read-Only Memory (EPROM), Electrically Erasable Programmable Read-Only Memory (EEPROM), flash memory, magnetic card or light card. In other words, the readable medium includes any medium for storing or transmitting information in a device (for example, computer) readable form.

A person skilled in the art may understand that each frame in these structure diagrams and/or block diagrams and/or flowcharts and combinations of frames in these structure diagrams and/or block diagrams and/or flowcharts may be implemented by computer program instructions. A person skilled in the art may understand that these computer program instructions may be provided to general-purpose computers, special-purpose computers or other processors of programmable data processing method for implementation, thus executing solutions designated in one or more frames in the structural diagrams and/or the block diagrams and/or the flowcharts disclosed by the present invention by the computers or other processors of programmable data processing method.

A person skilled in the art may understand that the steps, measures and solutions in various operations, methods and flows which have been discussed in the present invention may be alternated, changed, combined or deleted. Further, other steps, measures and solutions in various operations, methods and flows which have been discussed in the present invention may also be alternated, changed, rearranged, decomposed, combined or deleted. Further, the steps, measures and solutions in various operations, methods and flows disclosed in the present invention in the prior art may also be alternated, changed, rearranged, decomposed, combined or deleted.

The above is only a part of implementations of the present invention. It should be pointed out that, for an ordinary person skilled in the art, the present invention may have various improvements and embellishments without departing from the principle of the present invention. These improvements and embellishments should also be regarded as falling into the protection scope of the present invention.

1. A method for running an Android application on a Windows system, comprising:
loading a relevant file in a dynamic link library of an Android virtual machine by loading a Linux executable file of a predetermined format in response to an instruction for starting an application to start the Android virtual machine;
beginning to load the relevant file in the dynamic link library of the application;
loading a predetermined engine file and a relevant executable file in the application by starting the Android virtual machine;
invoking an Activity resource corresponding to the application by invoking a predetermined starting process; and
finishing loading the relevant file in the dynamic link library of the application in a life cycle of the Activity resource to run the application.

2. The method according to claim 1, wherein the loading a relevant file in a dynamic link library of an Android virtual machine comprises:
loading the relevant file in the dynamic link library of the Android virtual machine by the predetermined starting process, wherein
the finishing loading the relevant file in the dynamic link library of the application in a life cycle of the Activity resource comprises:
finishing loading the relevant file in the dynamic link library of the application by the predetermined starting process in the life cycle of the Activity resource.

3. The method according to claim 1, wherein the predetermined engine file comprises a DEX-related file of an Android system, a relevant file in a dynamic link library of the Android system, and a relevant file in a dynamic link library of the application.

4. The method according to claim 1, further comprising:
receiving a Windows operating instruction of the application, and converting the Windows operating instruction to a corresponding Android operating instruction by the Android virtual machine.

5. The method according to claim 4, further comprising:
sending the converted Android operating instruction to the relevant file in the dynamic link library of the application; and
executing, by the application, a corresponding operation in the Windows system according to the received and converted Android operating instruction.

6. The method according to claim 5, wherein the sending the converted Android operating instruction to the relevant file in the dynamic link library of the application comprises at least one of following cases:
sending the converted Android operating instruction to the relevant file in the dynamic link library of the application according to a notification message of the Android virtual machine;
feeding the converted Android operating instruction acquired by invoking back to the relevant file in the dynamic link library of the application according to an invoked instruction of the application.

7. A computing device for running an Android application on a Windows system, comprising:
a memory having instructions stored thereon;
a processor configured to execute the instructions to perform operations for running an Android application on a Windows system, the operations comprising:
loading a relevant file in a dynamic link library of an Android virtual machine by loading a Linux executable file of a predetermined format in response to an instruction for starting an application to start the Android virtual machine;
beginning to load the relevant file in the dynamic link library of the application;
loading a predetermined engine file and a relevant executable file in the application by starting the Android virtual machine;
invoking an Activity resource corresponding to the application by invoking a predetermined starting process; and
finishing loading the relevant file in the dynamic link library of the application in a life cycle of the Activity resource to run the application.

8. The computing device according to claim 7, wherein the operation of beginning to load the relevant file in the dynamic link library of the application comprises:
loading the relevant file in the dynamic link library of the Android virtual machine by the predetermined starting process;
wherein the operation of finishing loading the relevant file in the dynamic link library of the application in a life cycle of the Activity resource to run the application comprises: finishing loading the relevant file in the dynamic link library of the application by the predetermined starting process in the life cycle of the Activity resource.

9. The computing device according to claim 7, wherein the predetermined engine file comprises a DEX-related file of an Android system, a relevant file in a dynamic link library of the Android system, and a relevant file in a dynamic link library of the application.

10. The computing device according to claim 7, wherein the operations further comprise:
receiving a Windows operating instruction of the application and convert the Windows operating instruction to a corresponding Android operating instruction by the Android virtual machine.

11. The computing device according to claim 10, wherein the operations further comprise:
sending the converted Android operating instruction to the relevant file in the dynamic link library of the application; and
executing a corresponding operation in the Windows system according to the received and converted Android operating instruction of the application.

12. The computing device according to claim 11, wherein the operation of sending the converted Android operating instruction to the relevant file in the dynamic link library of the application further comprises: sending the converted Android operating instruction to the relevant file in the dynamic link library of the application according to a notification message of the Android virtual machine; or
feeding the converted Android operating instruction acquired by invoking back to the relevant file in the dynamic link library of the application according to an invoked instruction of the application.

13. (canceled)

14. A non-transitory computer-readable medium having computer programs stored thereon that, when executed by one or more processors of a computing device, cause the computing device to perform operations for running an Android application on a Windows system, the operations comprising:
loading a relevant file in a dynamic link library of an Android virtual machine by loading a Linux executable file of a predetermined format in response to an instruction for starting an application to start the Android virtual machine;
beginning to load the relevant file in the dynamic link library of the application;
loading a predetermined engine file and a relevant executable file in the application by starting the Android virtual machine;
invoking an Activity resource corresponding to the application by invoking a predetermined starting process; and
finishing loading the relevant file in the dynamic link library of the application in a life cycle of the Activity resource to run the application.

15. The non-transitory computer-readable medium according to claim 14, wherein the operation of loading a relevant file in a dynamic link library of an Android virtual machine comprises:
loading the relevant file in the dynamic link library of the Android virtual machine by the predetermined starting process, wherein
the operation of finishing loading the relevant file in the dynamic link library of the application in a life cycle of the Activity resource comprises:
finishing loading the relevant file in the dynamic link library of the application by the predetermined starting process in the life cycle of the Activity resource.

16. The non-transitory computer-readable medium according to claim 14, wherein the predetermined engine file comprises a DEX-related file of an Android system, a relevant file in a dynamic link library of the Android system, and a relevant file in a dynamic link library of the application.

17. The non-transitory computer-readable medium according to claim 14, wherein the operations further comprise:
receiving a Windows operating instruction of the application, and converting the Windows operating instruction to a corresponding Android operating instruction by the Android virtual machine.

18. The non-transitory computer-readable medium according to claim 17, wherein the operations further comprise:
sending the converted Android operating instruction to the relevant file in the dynamic link library of the application; and
executing, by the application, a corresponding operation in the Windows system according to the received and converted Android operating instruction.

19. The non-transitory computer-readable medium according to claim 16, wherein the operation of sending the converted Android operating instruction to the relevant file in the dynamic link library of the application comprises at least one of following cases:
sending the converted Android operating instruction to the relevant file in the dynamic link library of the application according to a notification message of the Android virtual machine; and
feeding the converted Android operating instruction acquired by invoking back to the relevant file in the dynamic link library of the application according to an invoked instruction of the application.
